(19) United States
(12) Patent Application Publication
(10) Pub. No.: US 2014/0202288 A1
(43) Pub. Date: Jul. 24, 2014

(54) GRIP ASSEMBLY FOR A TOOL BIT

(71) Applicant: A-TINA TOOLS CO., LTD., Taichung City (TW)

(72) Inventor: Kun-Chen CHEN, Taichung City (TW)

(73) Assignee: A-TINA TOOLS CO., LTD., Taichung City (TW)

(21) Appl. No.: 13/749,320

(22) Filed: Jan. 24, 2013

(51) Int. Cl. B25B 17/00

(52) U.S. Cl. CPC B25B 17/00
USPC 81/177.1

(57) ABSTRACT

A grip assembly for a tool bit has a grip, a driving device and an axle. The driving device is inserted into the grip and has a holding member, a gear unit and a sleeve. The gear unit has multiple gears and a ring. The gears are rotatably mounted in the holding member. The ring is mounted around and engages the gears. The sleeve is mounted around and engages the ring. The axle is rotatably mounted in the holding member and is engaged by the gears. When the sleeve is rotated, the gears are rotated. Accordingly, the axle is rotated by the gears such that a tool bit loosens a screw in continuous motion.

### BACKGROUND OF THE INVENTION

1. Field of the Invention

The present invention relates to a grip assembly for a tool bit, and more particularly to a grip assembly that can quickly rotate along an axle with a speed-up gear ratio.

2. Description of Related Art

With reference to FIG. 7, a conventional grip assembly 60 with a ratchet function is used to connect with a tool bit, and has a grip 61, a ratchet device 62 and an axle 63. The ratchet device 62 is mounted on an end of the grip 61. The axle 63 is inserted into the ratchet device 62. The ratchet device 62 enables continuous rotary motion of the axle 63 in a one-way direction. The axle 63 can receive different tool bits. Accordingly, the grip assembly 60 along with tool bits can loosen or tighten different screws. However, the conventional grip assembly 60 is inconvenient and awkward for rotation when a user is in a limited space, and using the grip assembly 60 is laborious when a long bolt has to be turned.

Accordingly, a pneumatic or power-driven grip assembly is also widely used to quickly and automatically loosen or tighten different screws, and is relatively labor-saving.

However, the power-driven grip assembly is hard to adjust a rotational force. A screw is often over-tightened by the power-driven grip assembly, and is easily fractured. Furthermore, a cross notch of a head of the screw is easily worn by the power-driven grip assembly.

To overcome the shortcomings, the present invention tends to provide a grip assembly for a tool bit to mitigate the aforementioned problems.

### SUMMARY OF THE INVENTION

The main objective of the invention is to provide a grip assembly that can quickly rotate along an axle with a speed-up gear ratio.

A grip assembly for a tool bit has a grip, a driving device and an axle. The driving device is inserted into the grip and has a holding member, a gear unit and a sleeve. The gear unit has multiple gears and a ring. The gears are rotatably mounted in the holding member. The ring is mounted around and engages the gears. The sleeve is mounted around and engages the ring. The axle is rotatably mounted in the holding member and is engaged by the gears. When the sleeve is rotated, the gears are rotated. Accordingly, the axle is rotated by the gears such that a tool bit loosens a screw in continuous motion.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a grip assembly for a tool bit in accordance with the present invention;

FIG. 2 is a partially exploded perspective view of the grip assembly in FIG. 1;

FIG. 3 is an enlarged side view in partial section of the grip assembly in FIG. 1;

FIG. 4 is an enlarged operational cross sectional top view of the grip assembly in FIG. 1;

FIG. 5 is an operational side view in partial section of the grip assembly in FIG. 1 showing that the grip is rotated;

FIG. 6 is an operational side view in partial section of the grip assembly in FIG. 1 showing that the sleeve is rotated; and

FIG. 7 is a perspective view of a conventional grip assembly for a tool bit in accordance with the prior art.

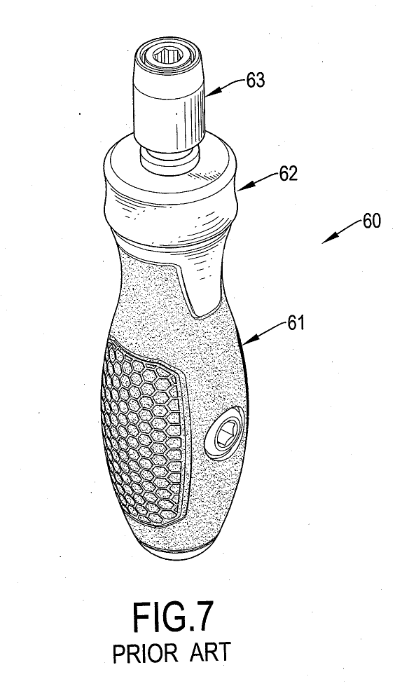

### DETAILED DESCRIPTION OF PREFERRED EMBODIMENT

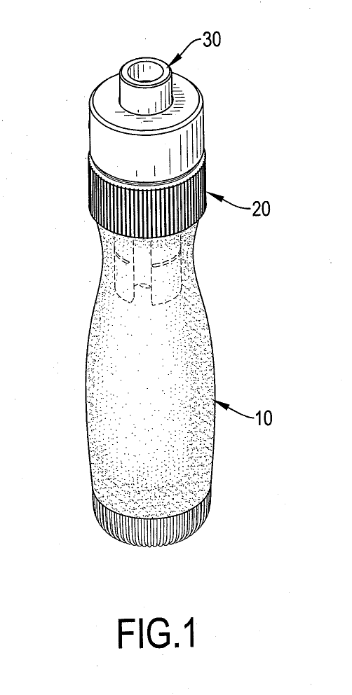

With reference to FIGS. 1 to 3, a grip assembly for a tool bit in accordance with the present invention comprises a grip 10, a driving device 20 and an axle 30.

The grip 10 has an end and a grip recess 11. The grip recess 11 is axially formed in the end of the grip 10.

The driving device 20 is connected with the grip 10 and has a holding member 21, a bearing 22, a gear unit 23, a bracket 24 and a sleeve 25.

The holding member 21 is inserted into the grip recess 11 and has a distal end, an outer surface, a ratchet device 210, a switch 211, a bearing-mounted section 212, a post 213, multiple gear recesses 214, multiple flutes 215, multiple shaft holes 216 and a member hole 217.

The ratchet device 210 is mounted at the distal end of the holding member 21, is located outside the grip recess 11 and has two pawls 2102.

The switch 211 is rotatably mounted around the ratchet device 210 and is capable of selectively switching the pawls 2102. The ratchet device 210 and the switch 211 may be conventional, and detailed description is omitted.

The bearing-mounted section 212 is located below the ratchet device 210 and is integrally and securely connected with the ratchet device 210.

The post 213 is axially and integrally connected with the bearing-mounted section 212, and is inserted into the grip recess 11. The bearing-mounted section 212 is formed between the ratchet device 210 and the post 213.

The gear recesses 214 are radially formed in the outer surface of the holding member 21 at intervals, are preferably formed in the outer surface of the post 213 and are adjacent to the bearing-mounted section 212. Preferably, three gear recesses 214 are implemented.

The flutes 215 are formed in the post 213 and respectively extend along a line parallel to an axis of the post 213. Number of the flutes 215 is the same as that of the gear recesses 214.

Number of the shaft holes 216 is the same as that of the gear recesses 214. The shaft holes 216 are formed in the post 213, respectively communicate with the gear recesses 214, respectively extend along a line parallel to the axis of the post 213, and respectively communicate with the flutes 215.

The member hole 217 is axially formed through the holding member 21 and communicates with the gear recesses 214.

The bearing 22 is securely mounted around the holding member 21 and is adjacent to the switch 211.

The gear unit 23 has multiple gears 231 and a ring 232.

The gears 231 are respectively and rotatably mounted in the gear recesses 214.

The ring 232 is rotatable, is mounted around and engages the multiple gears 231 and has an outer surface, an inner surface 2321 and multiple grooves 2322. The inner surface 2321 of the ring 232 is toothed and is mounted around and engages the multiple gears 231. The grooves 2322 are formed in the outer surface of the ring 232 and respectively extend along a line parallel to an axis of the ring 232.

The bracket 24 is connected with the holding member 21, is adjacent to the gear unit 23 and has a plate and multiple shafts 242.

The plate is mounted around the holding member 21, abuts the ring 232 and has multiple bracket holes 241. The bracket holes 241 are formed through the plate and respectively align with the shaft holes 216.

The shafts 242 are respectively mounted through the bracket holes 241 of the plate of the bracket 24, are respectively and axially mounted through the multiple gears 231, and are respectively and securely inserted into the shaft holes 216. Accordingly, the gears 231 can rotate relative to the shafts 242.

The sleeve 25 is rotatable, is securely mounted around the bearing 22 and engages the grooves 2322 of the ring 232, and has an outer surface and multiple notches. The notches are formed in the outer surface of the sleeve 25 and help the sleeve 25 to be rotated.

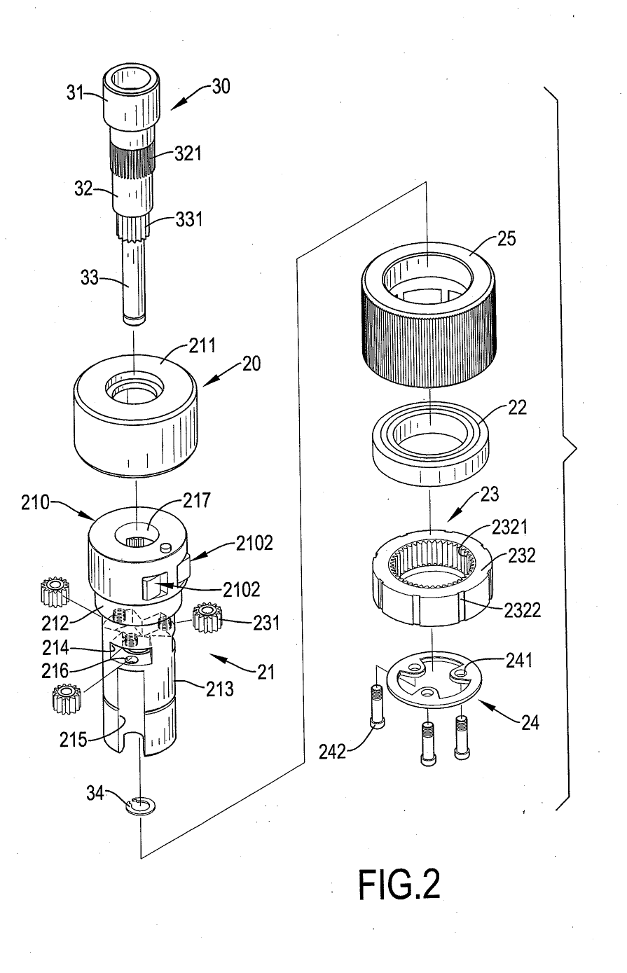

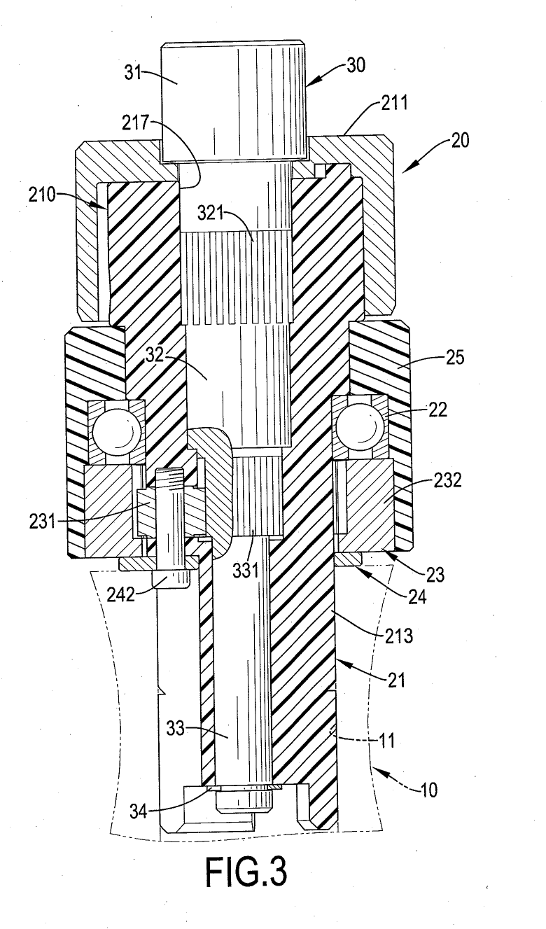

With reference to FIGS. 2 and 3, the axle 30 is rotatably mounted in the member hole 217, is engaged by the multiple gears 231, and has a distal end, a shank-receiving section 31, a first rod section 32, a second rod section 33 and a C-shaped clip 34.

The shank-receiving section 31 is fowled at the distal end of the axle 30. The first rod section 32 is securely connected with the shank-receiving section 31 and has a diameter, an outer surface and a first toothed section 321. The first toothed section 321 is formed around the outer surface of the first rod section 32 and is engaged by the pawls 2102.

The second rod section 33 is securely connected with the first rod section 32 and has a diameter, an outer surface and a second toothed section 331. The diameter of the second rod section 33 is smaller than that of the first rod section 32. The second toothed section 331 is formed around the outer surface of the second rod section 33 and is engaged by the multiple gears 231.

The C-shaped clip 34 is mounted around the second rod section 33 beside the second toothed section 331.

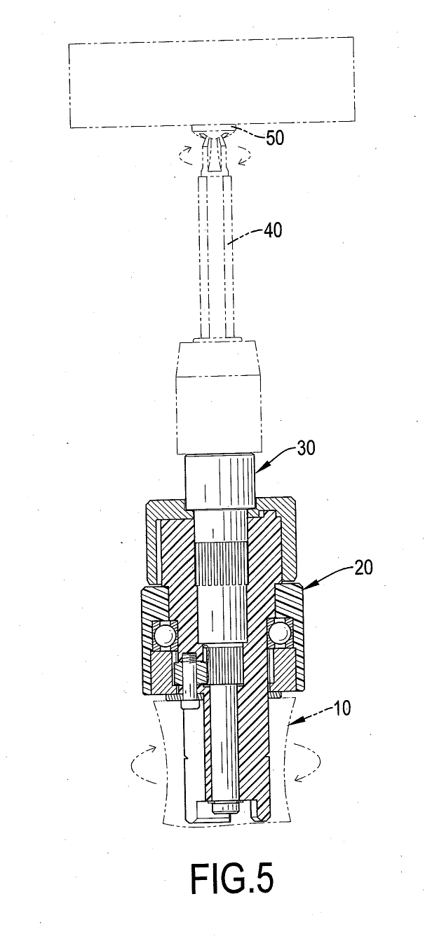

With reference to FIG. 5, the grip assembly in accordance with the present invention is being used to loosen a screw 50. A tool bit 40 is inserted into the shank-receiving section 31.

First, the ratchet device 210 is switched and enables continuous rotary motion of the axle 30 in a one-way direction, for example, a counterclockwise direction. Furthermore, the ratchet device 210 prevents clockwise rotation of the axle 30. Consequently, the grip 10 is rotated in a clockwise direction, such that the axle 30 is rotated by the grip 10 and the tool bit 40 initiates loosening the screw 50 in a clockwise direction.

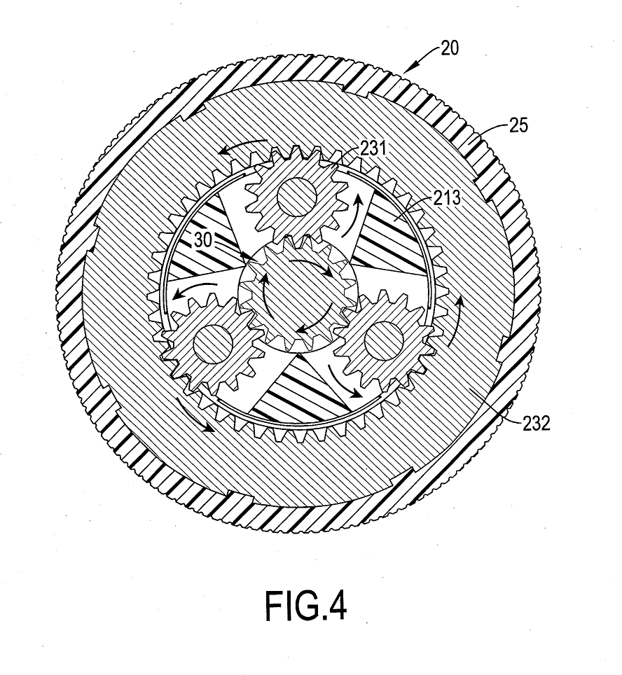

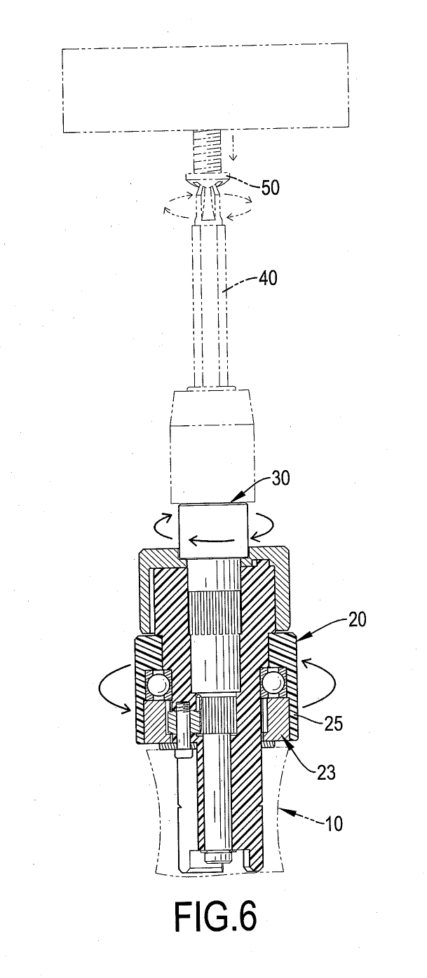

Second, the ratchet device 210 is switched and enables continuous rotary motion of the axle 30 in a clockwise direction, as shown in FIGS. 4 and 6.

When the sleeve 25 is rotated in a counterclockwise direction, the gears 231 are rotated in a clockwise direction. Accordingly, the axle 30 is rotated by the gears 231 in a clockwise direction, and the tool bit 40 quickly and continuously loosens the screw 50.

In addition, an inner diameter of the ring 232 is larger than an overall outer diameter of the three gears 231 and is also larger than an outer diameter of the axle 30, so a rotational speed of the axle 30 is larger than that of the sleeve 25 to form a speed-up ratio. Accordingly, the axle 30 can be quickly rotated and the tool bit 40 can also quickly loosen or tighten the screw 50, and this is efficient and labor-saving.

Similarly, the grip assembly can also be used to tighten the screw 50 in a process reverse to said loosening process.

From the above description, it is noted that the present invention has the following advantages:

1. Quick and Labor-Saving Control:

The axle 30 can be quickly rotated by the gear unit 23 by means of an appropriate speed-up gear ratio and the tool bit 40 can also quickly loosen or tighten the screw 50, and this is efficient and labor-saving.

2. Semi-Automatic Mechanism:

When rotating the sleeve 25, a user can feel the feedback from the sleeve 25, the gear unit 23, the axle 30, the tool bit 40 and the screw 50. With the feedback, the user can adjust a rotational force of a hand to tighten the screw 50, and this can prevent the screw 50 from being over-tightened.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A grip assembly for a tool bit, the grip assembly comprising:
a grip having
an end; and
a grip recess formed in the end of the grip;
a driving device connected with the grip and having
a holding member inserted into the grip recess and having
a distal end;
an outer surface;
multiple gear recesses formed at intervals and radially in the outer surface of the holding member beside the distal end of the holding member; and
a member hole axially formed through the holding member, and communicating with the gear recesses;
a bearing securely mounted around the holding member;
a gear unit connected with the holding member and having
multiple gears respectively and rotatably mounted in the gear recesses; and
a rotatable ring mounted around and engaging the multiple gears, and having an outer surface;
a bracket connected with the holding member, adjacent to the gear unit, and having
a plate mounted around the holding member; and
multiple shafts mounted through the plate of the bracket, and respectively and axially mounted through the multiple gears; and
a rotatable sleeve securely mounted around the bearing, and engaging the outer surface of the ring; and
an axle rotatably mounted in the member hole, engaged by the multiple gears, and having
a distal end; and
a shank-receiving section formed at the distal end of the axle.

2. The grip assembly for a tool bit as claimed in claim 1, wherein the axle has
a first rod section securely connected with the shank-receiving section and having
a diameter;
an outer surface; and
a first toothed section formed around the outer surface of the first rod section; and
a second rod section securely connected with the first rod section and having
a diameter smaller than that of the first rod section;
an outer surface; and
a second toothed section formed around the outer surface of the second rod section and engaged by the multiple gears.

3. The grip assembly for a tool bit as claimed in claim 2, wherein the ring has
an outer surface; and
multiple grooves formed in the outer surface of the ring, respectively extending along a line parallel to an axis of the ring, and engaged by the sleeve.
